(19) United States
(12) Patent Application Publication
(10) Pub. No.: US 2019/0131609 A1
(43) Pub. Date: May 2, 2019

(54) ELECTRICAL CONNECTION STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Naoki FUKUSHIMA, Mie (JP); Osamu NAKAYAMA, Mie (JP); Katsushi MIYAZAKI, Mie (JP); Seishi KIMURA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 16/090,977

(22) PCT Filed: Mar. 28, 2017
(86) PCT No.: PCT/JP2017/012549

§ 371 Date: Oct. 3, 2018

(30) Foreign Application Priority Data
Apr. 8, 2016 (JP) 2016-078114

(51) Int. Cl. H01M 2/20; H01M 2/30; H01R 4/34

(52) U.S. Cl. CPC H01M 2/206; H01M 2220/20; H01R 4/34; H01M 2/30

(57) ABSTRACT

Provided is an electrical connection structure including a first conductor, a second conductor, and a conductive sandwiched member sandwiched between the first conductor and the second conductor. A sharp projection protruding toward at least one of the first conductor and the second conductor is provided in a sandwiched region of the sandwiched member sandwiched between the first conductor and the second conductor. The sandwiched member is fixed to one of the first conductor and the second conductor.

### TECHNICAL FIELD

The technology disclosed in this specification relates to an electrical connection structure.

### BACKGROUND ART

In battery modules for electric cars and hybrid cars, for example, a plurality of single cells each having a positive electrode terminal and a negative electrode terminal are lined up in a row. In such battery modules, the plurality of single cells are electrically connected to each other by connecting a positive electrode terminal (positive terminal) and a negative electrode terminal (negative terminal) that are adjacent to each other using a bus bar formed of a conductive metal plate.

### CITATION LIST

Patent Document
Patent Document 1: JP 2015-15091A

### SUMMARY OF INVENTION

### Technical Problem

If there is an oxide film on a surface of one of two conductors that are connected to establish conductive connection as described above, a problem arises in that the oxide film interferes with the contact between the conductors and the contact resistance thus exceeds a prescribed value.

Therefore, it is conceivable to plate the conductors in order to reduce the contact resistance, but a problem arises in that the production cost increases because plating is expensive.

The technology disclosed in this specification was accomplished based on the above-mentioned circumstances, and the object thereof is to reduce the contact resistance between conductors that are electrically connected.

### Solution to Problem

The technology disclosed in this specification is an electrical connection structure including a first conductor, a second conductor, and a conductive sandwiched member sandwiched between the first conductor and the second conductor, wherein a sharp projection protruding toward at least one of the first conductor and the second conductor is provided in a sandwiched region of the sandwiched member sandwiched between the first conductor and the second conductor, and the sandwiched member is fixed to one of the first conductor and the second conductor.

With the above-mentioned configuration, when establishing conductive connection between the first conductor and the second conductor, the projection provided in the sandwiched region of the sandwiched member is pressed against an oxide film formed on the surface of at least one of the first conductor and the second conductor with a relatively strong force and breaks through the oxide film, thus exposing a new surface. Therefore, this new surface and a partner member are connected via the sandwiched member, and the contact resistance is thus suppressed to a low level.

The above-mentioned electrical connection structure may also be configured as follows.

A configuration may be employed in which the projection is provided at a circumferential edge of the sandwiched member or an edge of an opening of the sandwiched member. With such a configuration, a burr or the like generated when the sandwiched member is produced through punching can be used as the projection, thus making it possible to reduce the production cost.

A configuration may be employed in which a locking portion is provided on one of the first or second conductor and the sandwiched member, and a locked portion that is locked to the locking portion is provided on the other. With such a configuration, a configuration in which the sandwiched member is fixed to one of the first conductor and the second conductor can be realized.

A configuration may be employed in which at least one of the first conductor and the second conductor is made of an aluminum-based metal, and the projection protrudes toward the aluminum-based metal side.

There is a problem in that the surfaces of members made of an aluminum-based metal are likely to oxidize. However, with the above-mentioned configuration, the projection can reliably break the oxide film formed on the surface of the aluminum-based metal.

A configuration may be employed in which one of the first conductor and the second conductor is an electrode terminal of an electricity storage element, and the other is a bus bar connected to the electrode terminal.

### Advantageous Effects of Invention

With the technology disclosed in this specification, the contact resistance between conductors can be reduced when conductors are electrically connected to each other.

### BRIEF DESCRIPTION OF DRAWINGS

FIG. 1 is a plan view of a single cell group of Embodiment 1.

FIG. 2 is a plan view of a battery module.

FIG. 3 is a right side view of the battery module.

FIG. 4 is a partially enlarged schematic diagram showing an electrical connection structure of the battery module.

FIG. 5 is an exploded perspective view showing the electrical connection structure of the battery module.

FIG. 6 is a plan view of a sandwiched member.

FIG. 7 is a side view of the sandwiched member.

FIG. 8 is a partially enlarged side view of the sandwiched member.

FIG. 9 is a cross-sectional view taken along line A-A in FIG. 6.

FIG. 10 is a cross-sectional view taken along line B-B in FIG. 6.

FIG. 11 is a partially enlarged plan view of a bus bar with the sandwiched member.

FIG. 12 is a partially enlarged front view of the bus bar with the sandwiched member.

FIG. 13 is a cross-sectional view taken along line C-C in FIG. 11.

FIG. 14 is a partially enlarged plan view showing a state in which the bus bar with the sandwiched member is fastened to a single cell.

FIG. 15 is a right side view showing the state in which the bus bar with the sandwiched member is fastened to the single cell.

FIG. 16 is a partially enlarged schematic diagram showing the electrical connection structure in which the bus bar with the sandwiched member is fastened to the single cell (cross-sectional view taken along line D-D in FIG. 14).

FIG. 17 is a plan view of a sandwiched member of Embodiment 2.

FIG. 18 is a cross-sectional view taken along line E-E in FIG. 17.

### DESCRIPTION OF EMBODIMENTS

### Embodiment 1

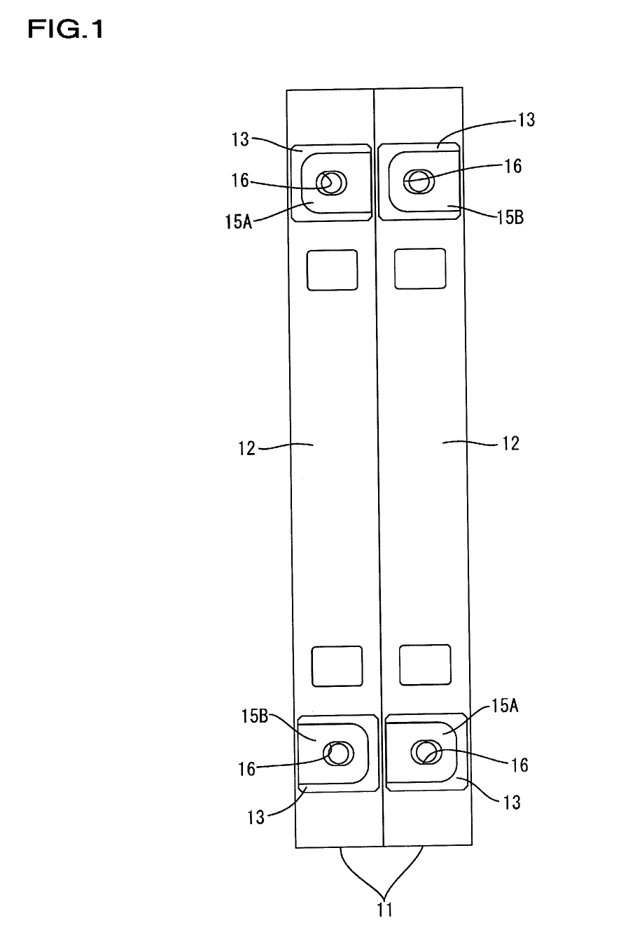

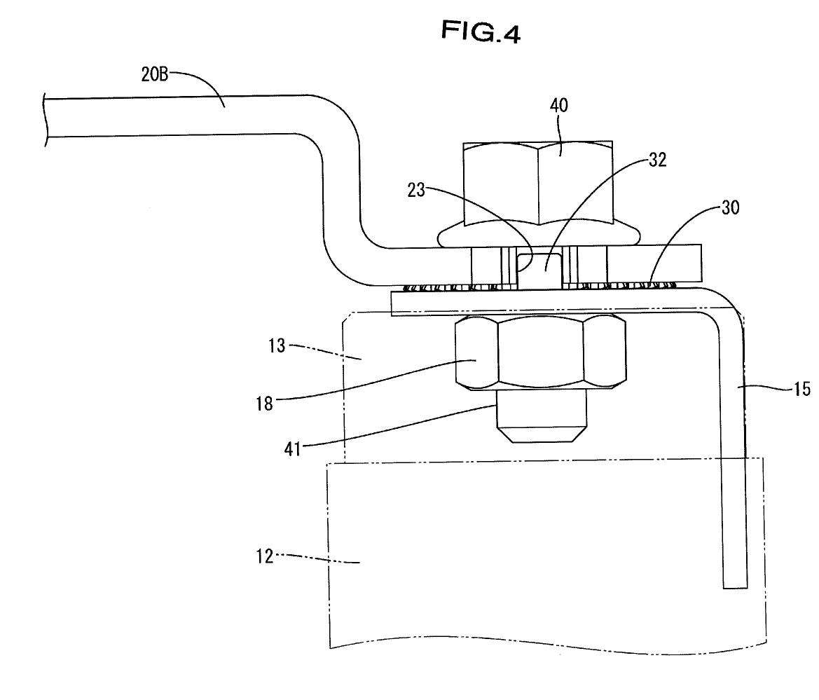

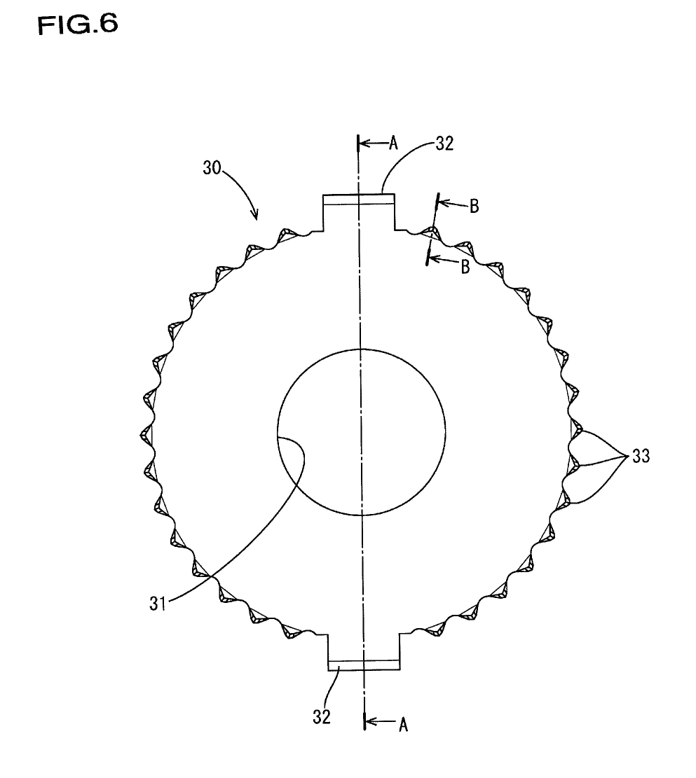

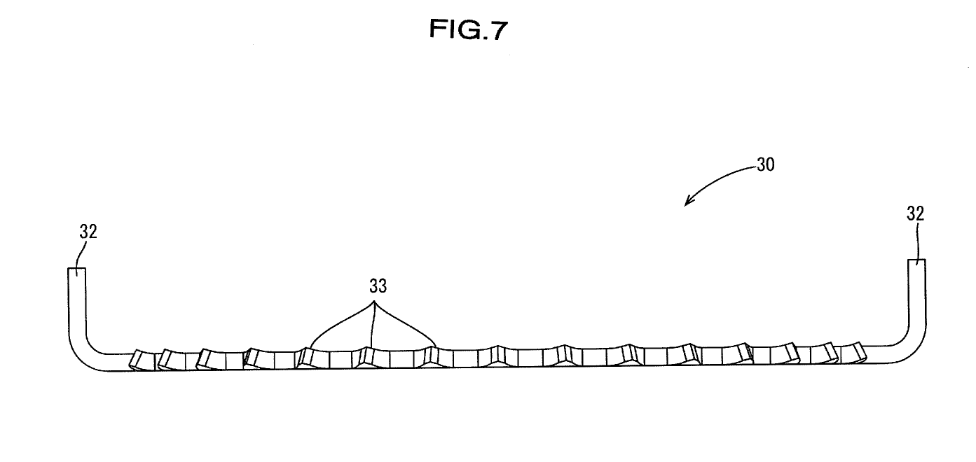

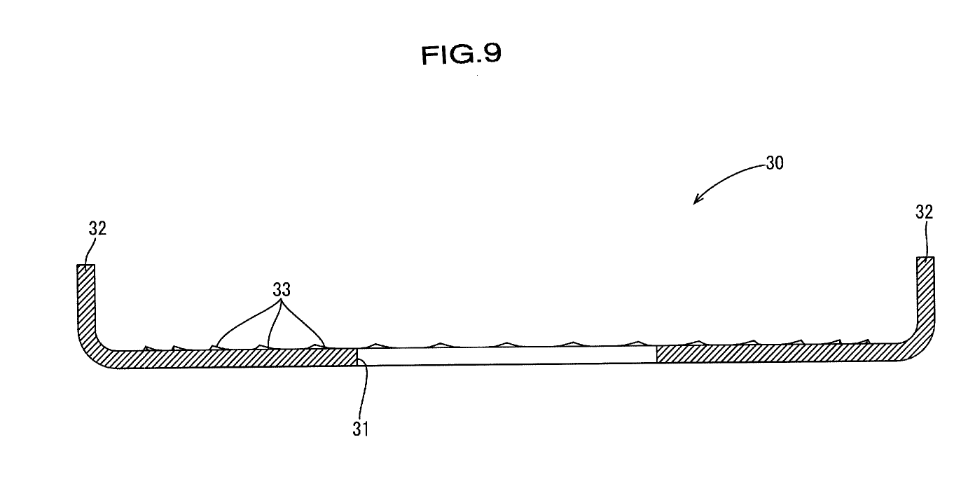

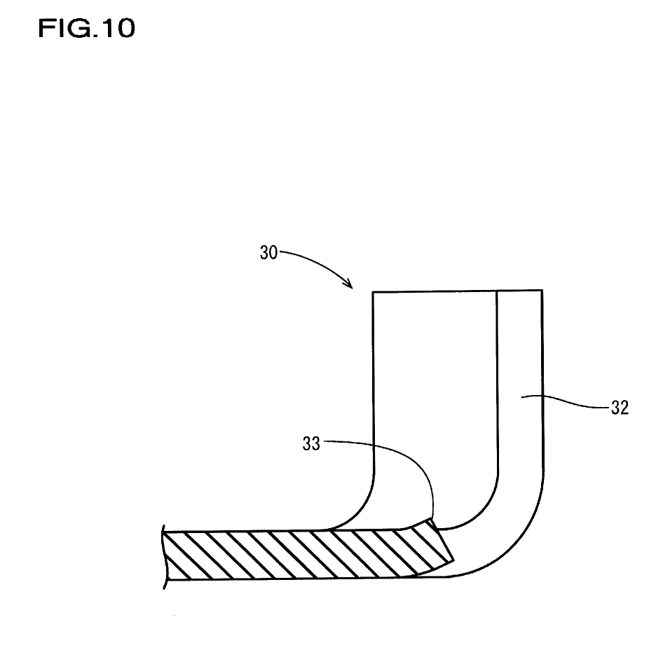

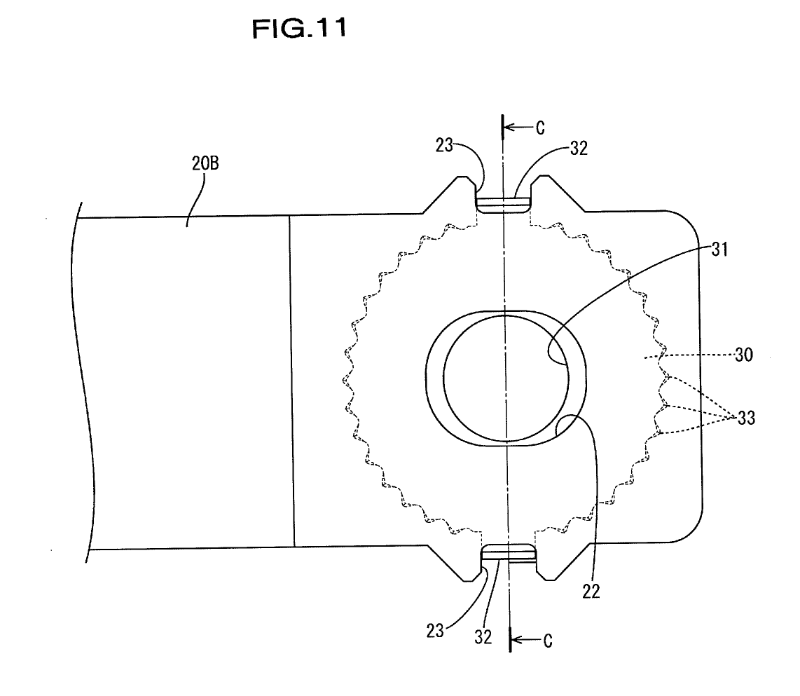

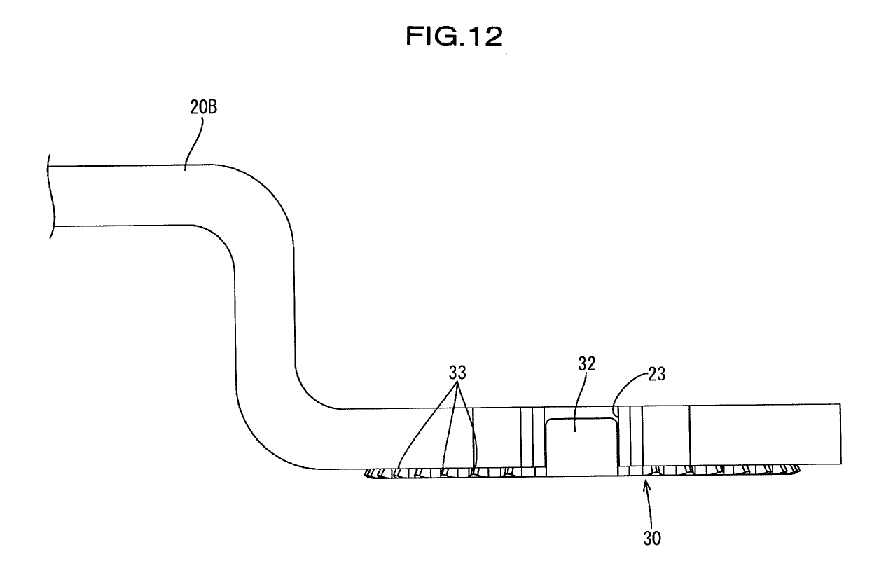

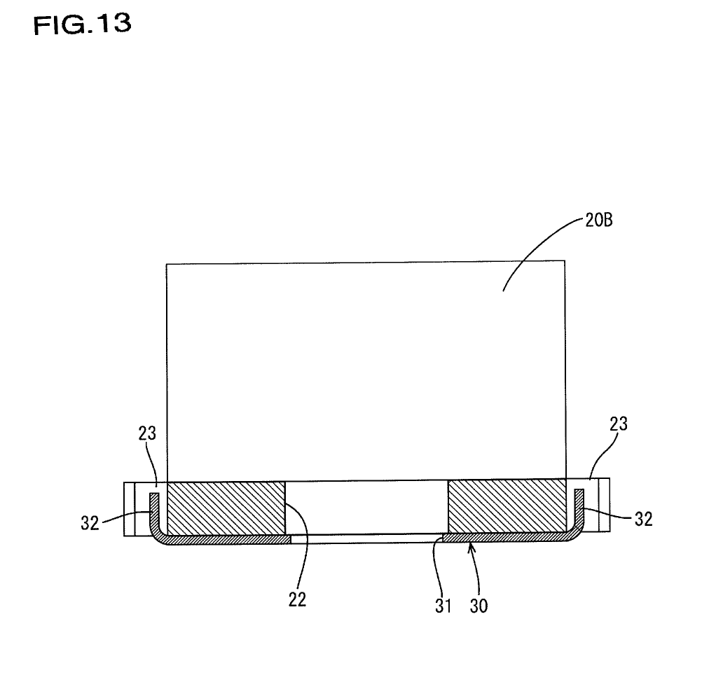

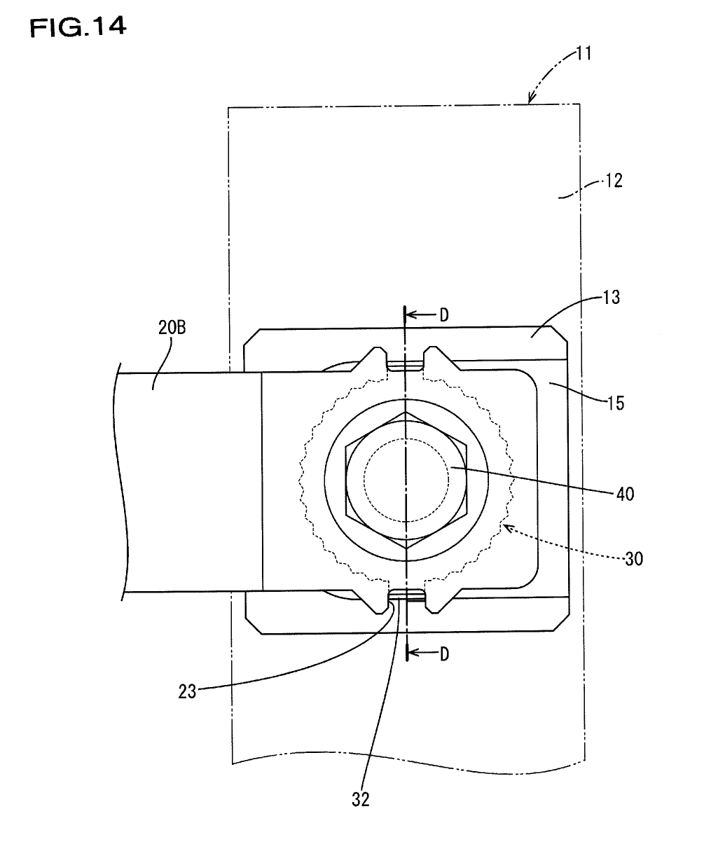

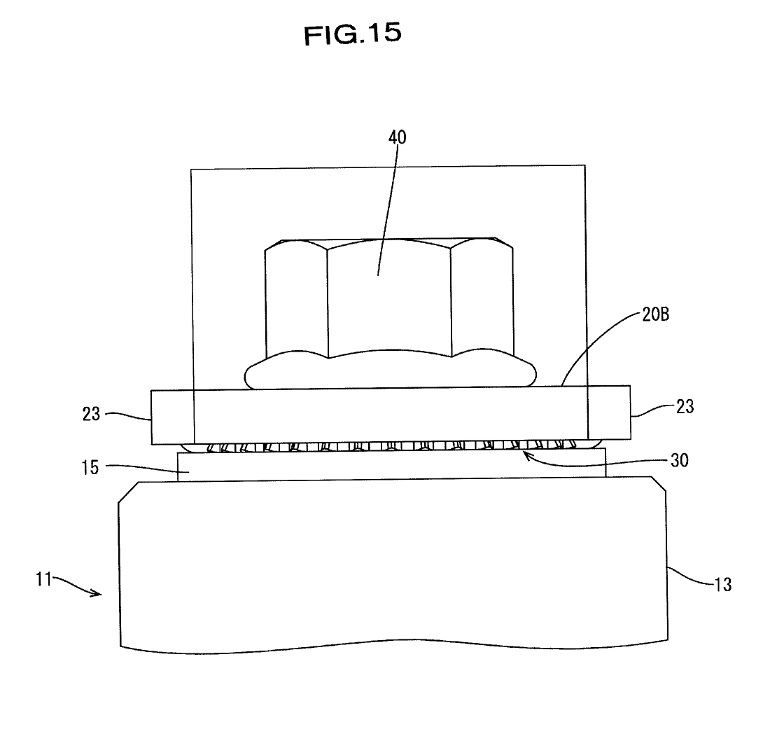

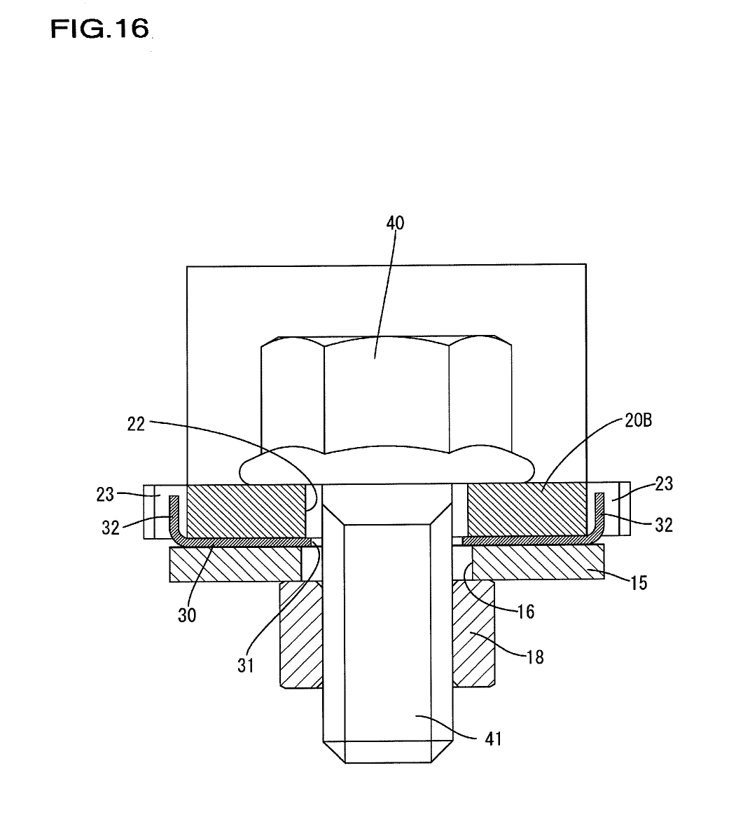

Embodiment 1 in which the above-mentioned technology is applied to a battery module will be described with reference to FIGS. 1 to 16. A battery module 10 (an example of an electricity storage module) of this embodiment is used as a driving source for an electric car or a hybrid car, for example. It should be noted that, in the following description, the lower side of FIG. 1 is referred to as the “front side”, the upper side thereof is referred to as the “rear side”, the right side thereof is referred to as the “right side”, and the left side thereof is referred to as the “left side”. In addition, the upper side of FIG. 4 is referred to as the “upper side”, and the lower side thereof is referred to as the “lower side”.

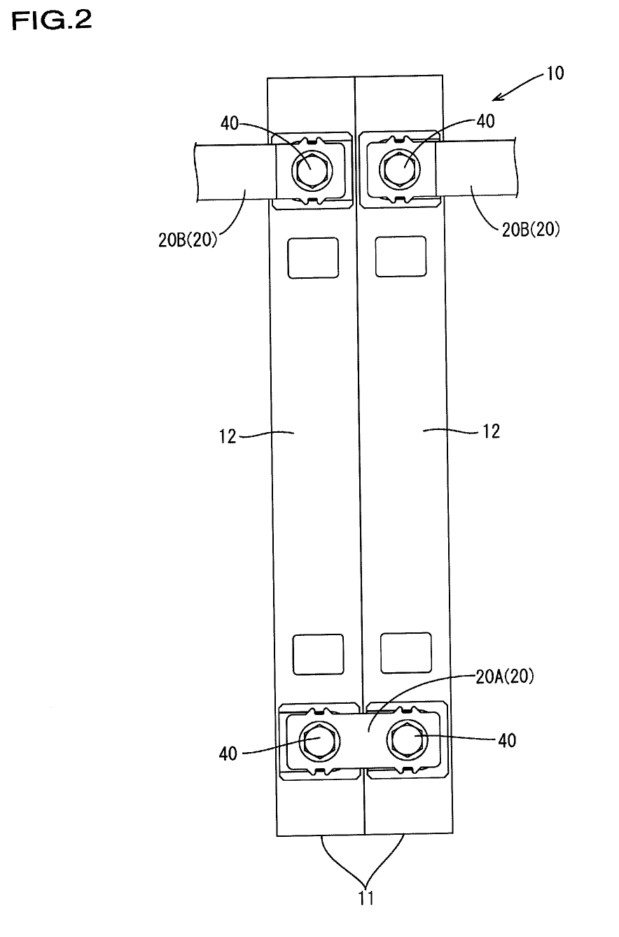

As shown in FIG. 2, the battery module 10 has a configuration in which a plurality of (two in this embodiment) adjacent single cells 11 that are lined up in a lateral direction, for example, are connected in series using a bus bar 20.

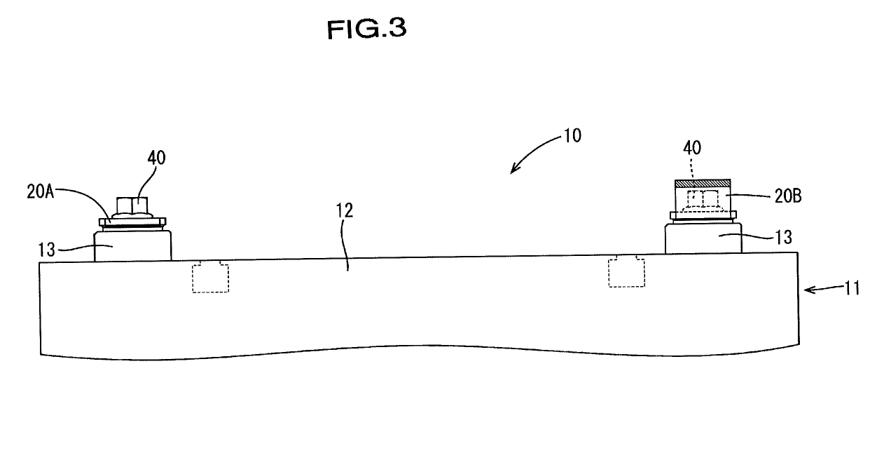

As shown in FIGS. 1 and 3, each single cell 11 includes a rectangular parallelepiped main body portion 12 inside which a power-generating element (not shown) is accommodated, and two terminal bases 13 protruding upward are provided near the respective ends of the upper surface of the main body portion 12. Electrode terminals 15 (a positive electrode is denoted by 15A and a negative electrode is denoted by 15B; examples of first conductors) that are made of copper and have a plate shape extend upward from the main body portion 12 along side surfaces of the terminal bases 13, and their leading ends are bent into an L-shape and placed on the terminal bases 13.

A nut 18 (electrode-side fastening portion) screwed onto a bolt 40 (fastening member), which will be described later, is fitted in each terminal base 13, and the electrode terminal 15 is provided with an insertion hole 16 through which a shaft 41 of the bolt 40 is inserted, at a region corresponding to the hole of the nut 18. This insertion hole 16 is formed in an elongated shape.

The polarities (positive or negative) of the respective single cells 11 are arranged such that those of neighboring single cells 11 are opposite to each other, and a configuration in which the electrode terminals 15A and 15B are adjacent to heteropolar electrode terminals is thus obtained. The plurality of single cells 11 are fixed by holding plates (not shown).

The electrode terminals 15A and 15B of neighboring single cells 11 are connected by a cell connection bus bar 20A (an example of a second conductor). An external connection bus bar 20B (an example of a second conductor) for connection with an external apparatus (not shown) is connected to an electrode terminal 15 on a side opposite to the electrode terminal 15 connected to the cell connection bus bar 20A. These bus bars 20A and 20B are made of aluminum or an aluminum alloy.

The cell connection bus bar 20A has a substantially rectangular plate shape, and is provided with insertion holes 22 through which the shafts 41 of the bolts 40 are inserted, near the respective ends in the longitudinal direction. The insertion holes 22 have an elongated shape that is elongated in the left-right direction (the longitudinal direction of the cell connection bus bar 20A).

The external connection bus bar 20B is an elongated plate member that has a crank shape. One end of the external connection bus bar 20B serves as a cell connection portion that is connected to the electrode terminal 15 of the single cell 11, and the other end serves as an external apparatus connection portion (not shown) that is connected to an external apparatus (not shown). The cell connection portion is also provided with an insertion hole 22 through which the shaft 41 of the bolt 40 is inserted, and this insertion hole 22 also has an elongated shape that is elongated in the left-right direction (the longitudinal direction of the external connection bus bar 20B).

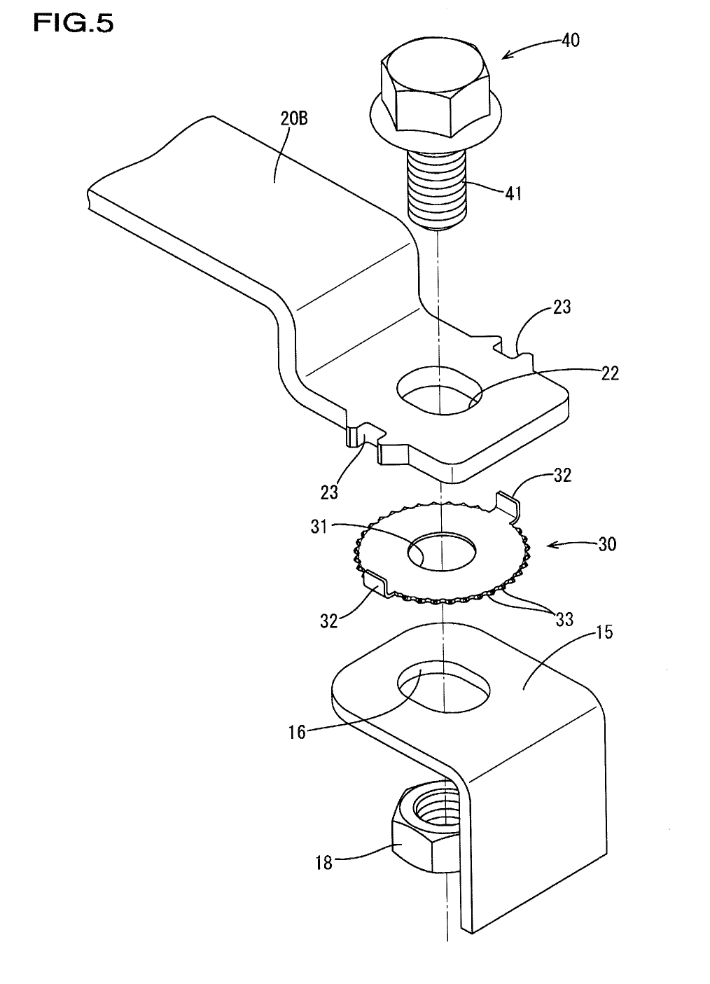

Furthermore, locked portions 23 that each protrude outward forming a U-shape and sandwich the side edges of a locking piece 32 of a sandwiched member 30, which will be described later, from both sides are provided at positions between which the insertion hole 22 is located, at the two edges extending in the longitudinal direction of each of the bus bars 20A and 20B (see FIG. 5).

In the battery module 10 of this embodiment, sandwiched members 30 are arranged between the bus bars 20A and 20B and the electrode terminals 15.

Each sandwiched member 30 is a substantially disc-shaped member made of a metal material such as copper or iron that has excellent conductivity and is harder than aluminum. In this embodiment, the sandwiched member 30 is made of copper, and its surface is plated with tin. The diameter of the sandwiched member 30 is set to be slightly smaller than the widths of the bus bar 20 and the electrode terminal 15, and its size is determined such that both surfaces excluding the locking pieces 32, which will be described later, are entirely in contact with the bus bar 20 and the electrode terminal 15 in a state in which the sandwiched member 30 is arranged between the bus bar 20 and the electrode terminal 15. In other words, the entire portion excluding the locking pieces 32 serves as a sandwiched region sandwiched between the bus bar 20 and the electrode terminal 15.

The central portion of the sandwiched member 30 is provided with a circular insertion hole 31 through which the shaft 41 of the bolt 40 is inserted.

The sandwiched member 30 is provided with two locking pieces 32 that are locked to the locked portions 23 of the bus bar 20. The two locking pieces 32 protrude outward from the outer circumferential edge with the insertion hole 31 being located therebetween, and are bent into an L-shape so as to extend upward (toward the bus bar 20 side). The widths of the locking pieces 32 are set such that the locking pieces 32 snugly fit into the above-described locked portions 23.

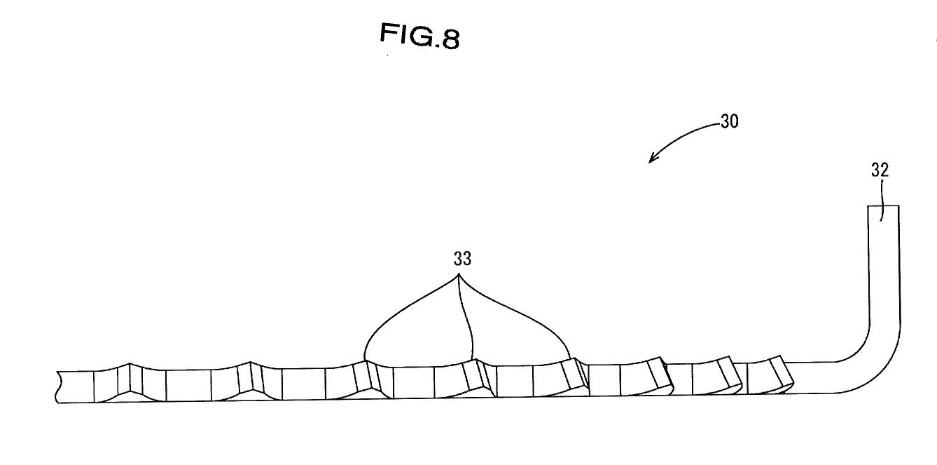

Furthermore, a large number of projections 33 are provided at the circumferential edge of the sandwiched member 30. As shown in FIG. 8, for example, each projection 33 has a mountain shape like a gear tooth that slightly protrudes obliquely upward (toward the bus bar 20 side) from the circumferential edge, and its leading end is sharp.

The battery module 10 of this embodiment has the above-described form. Next, the functions and effects will be described.

When the plurality of single cells 11 are connected using the bus bars 20, first, the sandwiched member 30 and the bus bar 20 are overlapped and integrated with the two locking pieces 32 of the sandwiched member 30 being fitted into the U-shaped locked portions 23 of the bus bar 20. The sandwiched member 30 and the bus bar 20, which were integrated, are placed at a predetermined position of the electrode terminal 15 in a state in which the sandwiched member 30 faces the electrode terminal 15. In this state, the insertion hole 22 of the bus bar 20, the insertion hole 31 of the sandwiched member 30, and the insertion hole of the nut 18 on the electrode side are aligned with one another. The shaft 41 of the washer faced hexagon bolt 40 (fastening member) for fastening is inserted from the bus bar 20 side, and the bolt 40 is screwed into the nut 18 on the electrode side.

As the bolt 40 is screwed into the nut 18 on the electrode side and fastened, the bus bar 20 is pressed against the sandwiched member 30, and the projections 33 provided on the sandwiched member 30 thus break through the oxide film (not shown) that covers the surface of the bus bar 20, resulting in the exposure of new surfaces. When the bolt is fastened more tightly, the leading ends of the projections 33 engage with the surface of the bus bar 20. That is, the new surfaces of the bus bar 20 and the electrode terminal 15 are electrically connected via the sandwiched member 30, and the contact resistance is thus reduced.

Accordingly, with the electrical connection structure of this embodiment, using the sandwiched member 30 including a large number of projections 33 in the battery module 10 makes it possible to suppress the contact resistance between the electrode terminal 15 and the bus bar 20 to a low level.

Since the sandwiched member 30 is formed in a disc shape with a diameter smaller than the width of the bus bar 20, and has a configuration in which a large number of projections 33 are provided at the circumferential edge, burrs or the like generated when the sandwiched member 30 is produced through punching can also be used as the projections 33. In this case, the production cost can be reduced.

Since a configuration is employed in which the locking pieces 32 are provided on the sandwiched member 30 and locked to the locked portions 23 provided on the bus bar 20 so that the sandwiched member 30 is integrally held by the bus bar 20, the workability of attaching the bus bar 20 to the electrode terminal 15 is excellent.

### Embodiment 2

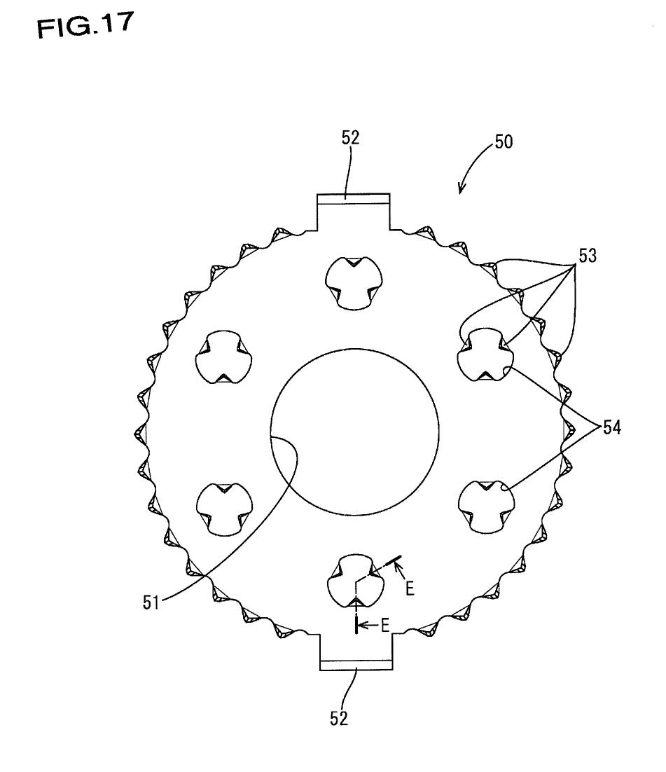

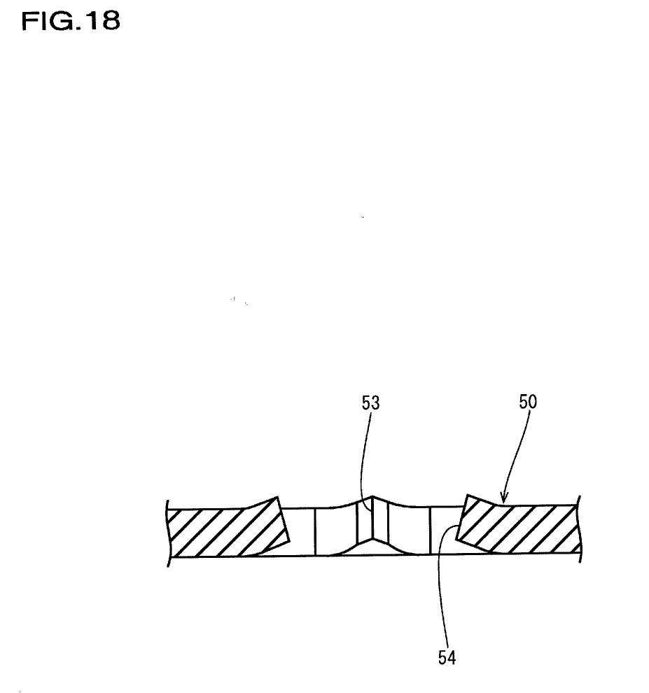

Next, Embodiment 2 will be described with reference to FIGS. 17 and 18. It should be noted that, hereinafter, only the differences between the configurations of this embodiment and the configurations of Embodiment 1 will be described, configurations similar to those in Embodiment 1 are denoted by reference numerals that are larger than those in Embodiment 1 by 20, and redundant descriptions are omitted.

A sandwiched member 50 used in a battery module of this embodiment differs from the above-mentioned sandwiched member 30 of Embodiment 1 in that circular through holes 54 (examples of openings) are provided.

Six through holes 54 are provided around an insertion hole 51 of the sandwiched member 50 (i.e., sandwiched region) at constant intervals. The opening edge of each through hole 54 is provided with projections 53 protruding in the same direction as the protruding direction of locking pieces 52 (i.e., protruding toward the bus bar side).

With the sandwiched member 50 of this embodiment, a larger number of projections 53 are provided. Therefore, more portions of an oxide film formed on the surface of the bus bar 20 are broken, and more new surfaces can thus be exposed. That is, the contact resistance between the electrode terminal 15 and the bus bar 20 can be suppressed to a lower level.

### OTHER EMBODIMENTS

The technology disclosed in this specification is not limited to the embodiments that have been described above with reference to the drawings, and embodiments such as those described below are also included in the technical scope of the present invention.

(1) The positions and shapes of the projections are not limited to those of the above-described embodiments, and can be changed as appropriate. For example, a configuration may be employed in which a large number of projections are provided by performing processing to form depressions and projections on the surface of the sandwiched region. Alternatively, the projections are not limited to the form where they are in contact with the bus bar or the electrode terminal in an interspersed manner, and may also have a form where they are in contact therewith in a linear manner (i.e., edged form).

(2) Although the above-described embodiments have configurations in which the sandwiched members 30 and 50 include the piece-like locking portions (locking pieces 32 and 52) that are locked to the locked portions 23 of the bus bar 20, the structure in which the sandwiched member and the bus bar are locked to each other is not limited to those in the above-described embodiments, and another form may also be employed. For example, a configuration in which locking pieces are provided on the bus bar may also be employed.

(3) Although the above-described embodiments have configurations in which the sandwiched members 30 and 50 are integrated with the bus bars 20 in advance, a configuration in which the sandwiched members 30 and 50 are integrated with the electrode terminals in advance can also be employed.

(4) A configuration in which the sandwiched member is integrated with the bus bar or the electrode terminal through welding in advance can also be employed.

(5) Alternatively, a configuration in which the locking portions and locked portions are omitted, and the sandwiched member and the bus bar are separately attached to the electrode terminal may also be employed.

(6) Although the above-described embodiments have configurations in which the nut 18 is provided on the single cell 11 side, and the electrode terminal 15 and the bus bar 20 are connected by fastening the bolt 40 to this nut 18, a configuration may also be employed in which an electrode terminal having a bolt-like shape is provided on the single cell side, and the electrode terminal and the bus bar are connected by fastening a nut to the electrode terminal.

(7) Although the above-described embodiments take the form in which the diameters of the sandwiched members 30 and 50 are set to be slightly smaller than the widths of the bus bar 20 and the electrode terminal 15, and the entire region excluding the locking pieces 32 serves as the sandwiched region sandwiched between the bus bar 20 and the electrode terminal 15, a form may also be employed in which the diameter of the sandwiched member is set to be larger than the widths of the bus bar 20 or the electrode terminal 15, and a portion thereof protrudes from the bus bar 20 or the electrode terminal 15. In this case, it is sufficient that a sufficient number of projections for breaking the oxide film are provided on portions (sandwiched regions) that are in contact with the bus bar 20 and the electrode terminal 15.

(8) The material of the sandwiched member is not limited to copper or iron, and the sandwiched member may also be made of another metal. In short, it is sufficient that the sandwiched member is made of a metal that has excellent conductivity and is hard enough to break the oxide film or plated film formed on the metal member.

(9) Although the bus bar 20 is made of an aluminum-based metal and the electrode terminal 15 is made of copper in the above-described embodiments, the bus bar may also be made of copper, the electrode terminal may also be made of an aluminum-based metal, both of them may also be made of an aluminum-based metal or copper, or both of them may also be made of another metal. A configuration in which the projections are provided on a surface of the sandwiched member facing a member made of an aluminum-based metal is preferable.

(10) Although the above-described embodiments have configurations in which the projections 33 and 53 protrude only from one side (bus bar 20 side) of the sandwiched members 30 and 50, a configuration in which projections protruding from the other side (electrode terminal 15 side) are also provided may also be employed.

### LIST OF REFERENCE NUMERALS

10: Battery module (electricity storage module)
11: Single cell (electricity storage element)
15: Electrode terminal (first conductor)
18: Nut
20: Bus bar (second conductor)
23: Locked portion
30, 50: Sandwiched member
32, 52: Locking piece (locking portion)
33, 53: Projection
54: Through hole (opening)
40: Bolt

1. An electrical connection structure comprising:
an electrode terminal of an electricity storage element,
a bus bar connected to the electrode terminal by fastening a fastening member to an electrode-side fastening portion provided on the electrode terminal side; and
a conductive sandwiched member sandwiched between the electrode terminal and the bus bar,
wherein a sharp projection protruding toward at least one of the electrode terminal and the bus bar is provided in a sandwiched region of the sandwiched member sandwiched between the electrode terminal and the bus bar, and
the sandwiched member is provided with two locking portions that are fitted into two locked portions provided in the bus bar, and is configured to be integrally fixed to the bus bar.

2. The electrical connection structure according to claim 1, wherein the projection is provided at a circumferential edge of the sandwiched member or an edge of an opening of the sandwiched member.

3. (canceled)

4. The electrical connection structure according to claim 1, wherein at least one of the electrode terminal and the bus bar is made of an aluminum-based metal, and the projection protrudes toward the aluminum-based metal side.

5. (canceled)

6. The electrical connection structure according to claim 2, wherein at least one of the electrode terminal and the bus bar is made of an aluminum-based metal, and the projection protrudes toward the aluminum-based metal side.
